(19) United States
(12) Patent Application Publication
(10) Pub. No.: US 2017/0280380 A1
(43) Pub. Date: Sep. 28, 2017

(54) METHOD TO DYNAMICALLY SWITCH DATA SUBSCRIPTION IN VOLTE + GSM DUAL SIM DUAL STANDBY DEVICE

(71) Applicant: QUALCOMM Incorporated, San Diego, CA (US)

(72) Inventors: Naresh GUNDU, Hyderabad (IN); Debesh Kumar SAHU, Hyderabad (IN); Bala Krishna KOTHA, Hyderabad (IN)

(21) Appl. No.: 15/080,361

(22) Filed: Mar. 24, 2016

(51) Int. Cl. H04W 48/18

(52) U.S. Cl. CPC H04W 48/18; H04W 88/06

(57) ABSTRACT

A method for dynamically switching a data subscription in a multi subscriber identity module (SIM) multi standby (MSMS) mobile communication device includes: in response to determining that signal energy for a first subscription detected during a background public land mobile network (BPLMN) search remains greater than or equal to a threshold signal energy value during a first specified time period of a first timer, reducing a second specified time period of a second timer for a second subscription; determining whether any data communication activity occurs on the second subscription during the second specified time period; in response to determining that no data communication activity occurs on the second subscription during the second specified time period, performing a dedicated data subscription (DDS) switch from a second subscription to the first subscription.

### BACKGROUND

A dual SIM dual standby (DSDS) mobile communication device may have a first subscriber identity module (SIM) (i.e., SIM1) having a long term evolution (LTE) subscription with voice over LTE (VoLTE) enabled and a second SIM (SIM2) with a global system for mobile communication (GSM) subscription. The LTE subscription may be designated as the dedicated data subscription (DDS). Currently, DSDS mobile communication devices do not support simultaneously attaching packet switched (PS) services on both subscriptions (i.e., Dual-PS attach).

If the LTE subscription on SIM1 goes to out of service (OOS), a DDS switch from the LTE subscription to the GSM subscription may be triggered if a data connection is used. In one example, access point (AP) code may trigger a DDS switch if a data connection is used. However, if there is a data connection, for example streaming data or a data download, ongoing through the GSM subscription on SIM2, a DDS switch back the LTE subscription on SIM1 may be delayed, or may not happen at all, when the LTE subscription on SIM1 come back into service.

In another example, an end user may switch the DDS to SIM2 and forget that the DDS was switched. The DDS will remain on SIM2 even if the LTE subscription becomes available on SIM1. Hence, VoLTE calls on SIM1 will be blocked even if LTE coverage becomes available on SIM1. For LTE only (with VoLTE) networks this may result in a revenue loss (i.e., a VoLTE mobile terminated (MT) call miss) as the mobile communication device spends more time on non-LTE networks.

FIG. 3 is a sequence diagram 300 illustrating a DDS switch for a conventional mobile communication device. Referring to FIG. 3, at block 330 SUB1 310 may be designated as the DDS and may be an LTE subscription with VoLTE enabled. SUB1 310 may communicate with a first network (NETWORK1) 320. At block 335, the LTE subscription on SUB1 310 may go OOS triggering a DDS switch to a GSM subscription (SUB2 315) on SIM2 at block 340. SUB2 315 may communicate with a second network (NETWORK2) 325. At block 345, SUB2 315 on SIM2 may carry on data communications with NETWORK2 325.

Subsequently, at block 350 the LTE subscription on SUB1 310 may come back into service. However, at block 355 SUB2 315 may remain as the DDS since at block 360 data communication on SUB2 315 may be ongoing with NETWORK2 325. As a result, VoLTE calls on SIM1 may be blocked even if LTE coverage is available.

### SUMMARY

Apparatuses and methods for dynamically switching a data subscription in dual SIM dual standby mobile communication device are provided.

According to various aspects there is provided a method for dynamically switching a data subscription in dual SIM dual standby mobile communication device. In some aspects, the method may include: in response to determining that signal energy for a first subscription detected during a background public land mobile network (BPLMN) search remains greater than or equal to a threshold signal energy value during a first specified time period of a first timer, reducing a second specified time period of a second timer for a second subscription; determining whether any data communication activity occurs on the second subscription during the second specified time period; in response to determining that no data communication activity occurs on the second subscription during the second specified time period, performing a dedicated data subscription (DDS) switch from a second subscription to the first subscription.

According to various aspects there is provided a multi subscriber identity module (SIM) multi standby (MSMS) mobile communication device. In some aspects, the mobile communication device may include: a communication unit configured to communicate with one or more communication networks; a memory operably connected to the communication unit; a timing unit configured to implement one or more timers; and a control unit operably connected to the communication unit, the memory, and the timing unit.

The control unit may be configured to: in response to determining that signal energy for a first subscription detected during a background public land mobile network (BPLMN) search remains greater than or equal to a threshold signal energy value during a first specified time period of a first timer, reduce a second specified time period of a second timer for a second subscription; determine whether any data communication activity occurs on the second subscription during the second specified time period; in response to determining that no data communication activity occurs on the second subscription during the second specified time period, perform a DDS switch from a second subscription to the first subscription.

According to various aspects there is provided a method for dynamically switching a data subscription in a multi subscriber identity module (SIM) multi standby (MSMS) mobile communication device. In some aspects, the method may include: initiating a background public land mobile network (BPLMN) search for a first communication network associated with a first subscription; determining whether signal energy for the first subscription is detected; in response to determining that the signal energy for the first subscription is detected, starting a first timer for a first specified time period; monitoring signal energy for the first subscription until expiration of the first specified time period; determining whether signal energy for the first subscription remains greater than or equal to a threshold signal energy value during the first specified time period; and in response to determining that the signal energy for the first subscription remains greater than or equal to the threshold signal energy value during the first specified time period, performing a dedicated data subscription (DDS) switch from a second subscription to the first subscription.

According to various aspects there is provided a multi subscriber identity module (SIM) multi standby (MSMS) mobile communication device. In some aspects, the mobile communication device may include: a communication unit configured to communicate with one or more communication networks; a memory operably connected to the communication unit; a timing unit configured to implement one or more timers; and a control unit operably connected to the communication unit, the memory, and the timing unit.

The control unit may be configured to: control the communication unit to initiate a background public land mobile network (BPLMN) search for a first communication network associated with a first subscription; determine whether signal energy for the first subscription is detected during the BPLMN search; in response to determining that the signal energy for the first subscription is detected during the BPLMN search, control the timing unit to start a first timer for a first specified time period; control the communication unit to monitor signal energy for the first subscription until expiration of the first specified time period; determine whether signal energy for the first subscription remains greater than or equal to a threshold signal energy value during the first specified time period; and in response to determining that the signal energy for the first subscription remains greater than or equal to the threshold signal energy value during the first specified time period, perform a dedicated data subscription (DDS) switch from a second subscription to the first subscription.

Other features and advantages should be apparent from the following description which illustrates by way of example aspects of the various teachings of the disclosure.

### BRIEF DESCRIPTION OF THE DRAWINGS

Aspects and features of the various examples will be more apparent by describing examples with reference to the accompanying drawings, in which:

FIG. 1A is a block diagram illustrating a mobile communication device according to various examples;

FIG. 1B is a diagram illustrating a network environment for various examples;

FIG. 2 is a flowchart illustrating a method for dynamically switching a data subscription for a mobile communication device according to various examples; and

FIG. 3 is a sequence diagram illustrating a DDS switch for a conventional mobile communication device.

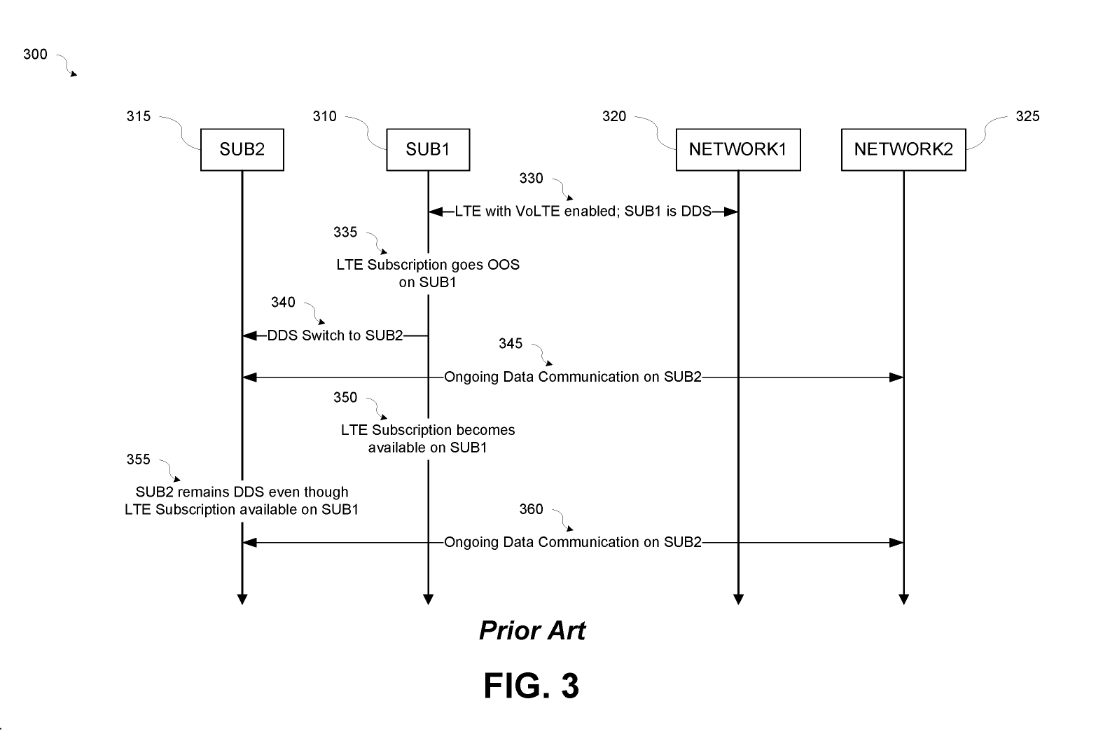

### DETAILED DESCRIPTION

While certain examples are described, these examples are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

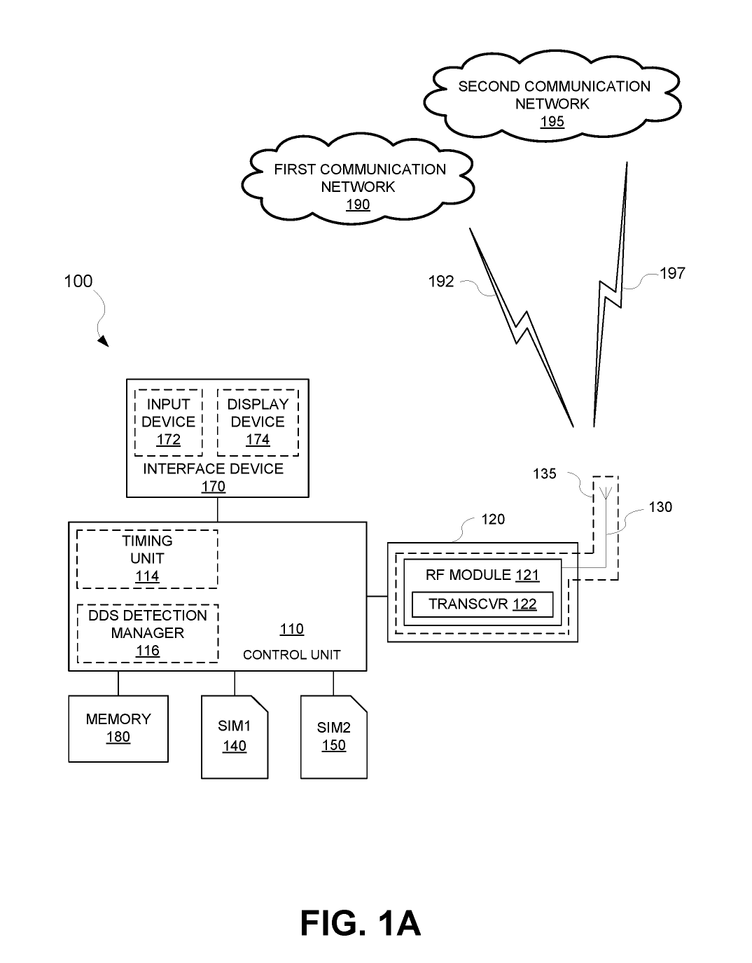

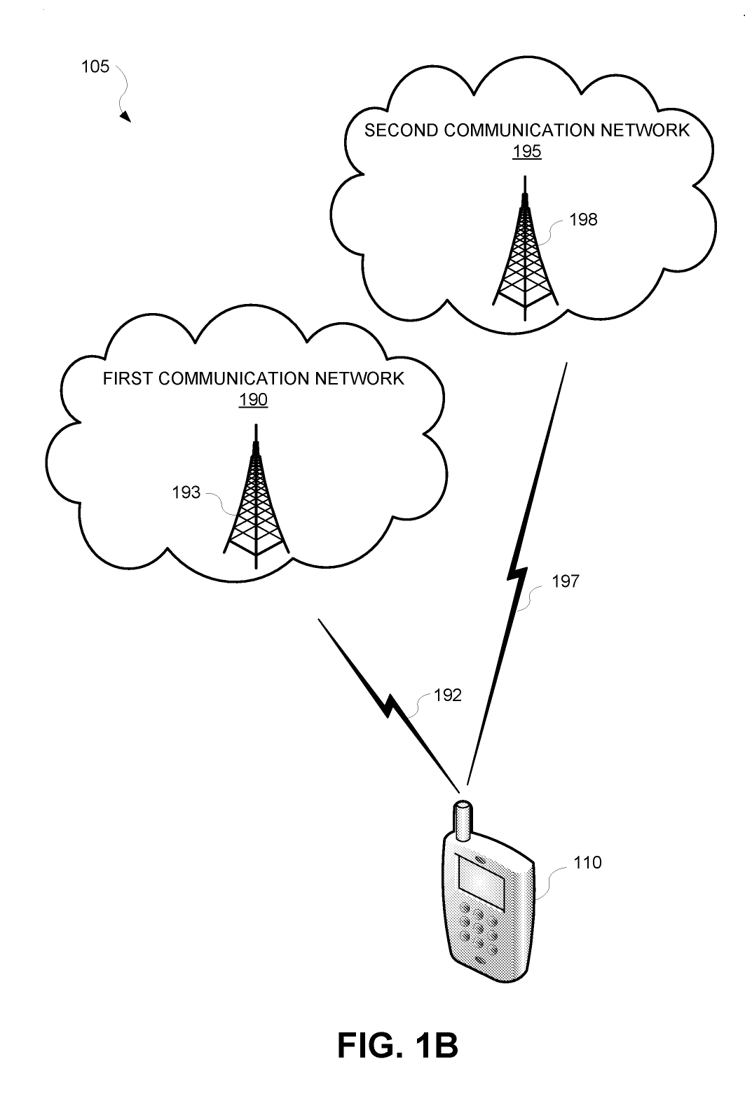

FIG. 1A is a block diagram illustrating a mobile communication device 100 according to various examples. As illustrated in FIG. 1A, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of protection.

The communication unit 120 may include, for example, but not limited to, an RF module 121. The RF module 121 may include, for example, but not limited to the first transceiver 122. An RF chain 135 may include, for example, but not limited to the antenna 130 and the RF module 121.

One of ordinary skill in the art will appreciate that examples of the mobile communication device 100 may include more than one communication unit and/or more than one antenna without departing from the scope of protection.

A SIM (for example the first SIM 140 and/or the second SIM 150) in various examples may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various examples may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various examples are described in terms of DSDS mobile communication devices. However, one of ordinary skill in the art will appreciate that the various examples may be extended to Multi-SIM Multi-Standby (MSMS) and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, wideband CDMA (WCDMA), and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various examples.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The control unit 110 may include a timing unit 114 configured to implement one or more timers and a DDS detection manager 116 configured to trigger a DDS switch between SIMs. Alternatively, the timing unit 114 and/or the DDS detection manager 116 may be implemented as electronic circuitry separate from the control unit 110.

The memory 180 may be configured to store operating systems and/or application programs for operation of the mobile communication device 100 that are executed by the control unit 110, as well as to store application data and user data.

FIG. 1B is a diagram illustrating a network environment 105 for various examples. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be an LTE network with voice over LTE (VoLTE) enabled and the first subscription 192 may be a GSM subscription. The second communication network 195 may be a GSM network. Alternatively, the second communication network 195 may implement another RAT including, for example, but not limited to, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various examples.

The mobile communication device 100 may attempt to acquire the first communication network 190 and camp on the first BTS 193. The mobile communication device 100 may also attempt to acquire the second communication network 195 and camp on the second BTS 198. A person's having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

The present method and apparatus provides a DDS detection manager which may trigger a DDS switch to a SIM (e.g., the first SIM 140) after LTE is back in-service on the SIM. The DDS detection manager may take into consideration RF conditions and/or LTE signal strength, for example, but not limited to, received power (RxPwr), signal-to-interference ratio (Ec/Io),etc., when deciding to which SIM the DDS should be switched and when to switch the DDS. In addition, the DDS detection manager may cause different timers to operate when deciding to which SIM the DDS should be switched. A message on the user interface may be used to notify the user of the DDS switch.

One of ordinary skill in the art will appreciate that the DDS detection manager may be implemented by the control unit 110 as circuitry and/or software. Alternatively, the DDS detection manager may be implemented as circuitry and/or software separate from the control unit 110.

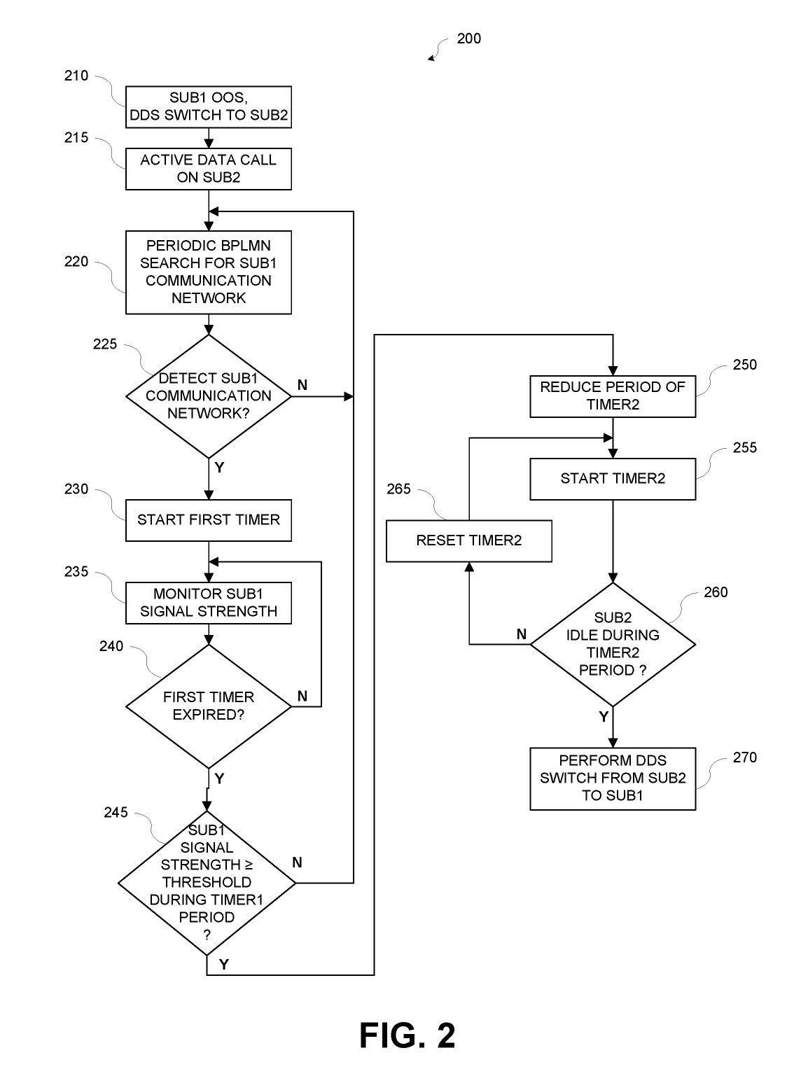

In various examples, one or more timers may be implemented to enable a mobile communication device to dynamically switch a data subscription. The DDS detection manager 116 may incorporate a hysteresis function, for example, but not limited to, using one or more timers, to avoid ping-ponging between two SIMs. FIG. 2 provides an example of DDS switching involving switching after a background public land mobile network (BPLMN) search of the SIM1 LTE frequency and a determination that there is PS dormancy on SIM2.

FIG. 2 is a flowchart illustrating a method 200 for dynamically switching a data subscription for a mobile communication device according to various examples. Referring to FIGS. 1A, 1B, and 2, at block 210, if Sub1 192 goes OOS the control unit 110 may trigger a DDS switch from Sub1 192 to Sub2 197. At block 215, a data call may be active on Sub2 197.

At block 220, the control unit 110 may control the communication unit 120 to perform a BPLMN search for a network (e.g., the first communication network 190) associated with Sub1 192. The control unit 110 may control the communication unit 120 to perform the BPLMN search during gaps in data communication during the active data call on Sub2 197. At block 225, control unit 110 may determine whether the first communication network 190 associated with Sub1 192 is detected. In response to determining that the first communication network 190 associated with Sub1 192 is not detected (225-N), the control unit 110 may control the communication unit 120 to continue performing the BPLMN search at block 220.

In response to determining that the first communication network 190 associated with Sub1 192 is detected (225-Y), at block 230 the control unit 110 may control the timing unit 114 to start a first timer. For example, the control unit 110 (e.g., the DDS detection manager 116) may control the timing unit 114 to implement the first timer configured to time a first specified time period and start the first timer. A value for the first specified time period may be, for example, but not limited to, five seconds. The value for the first specified time period may be configurable and may be stored in the memory 180.

At block 235 the control unit 110 may control the communication unit 120 to monitor the signal strength of the Sub1 192 signal from the first communication network 190. At block 240, the control unit 110 (e.g., the DDS detection manager 116) may determine whether the first timer has expired. In response to determining that the first timer has not expired (240-N), the control unit 110 may control the communication unit 120 to monitor the signal strength of the Sub1 192 signal from the first communication network 190 at block 235.

In response to determining that the first timer has expired (240-Y), the control unit 110 may determine whether the signal strength of the Sub1 192 signal from the first communication network 190 remained equal to or greater than a threshold value over the duration of the first specified time period of the first timer. For example, the control unit 110 (e.g., the DDS detection manager 116) may determine whether the signal strength of the Sub1 192 signal was equal to or greater than, for example, but not limited to, −85 dBm over the first specified time period of the first timer. The threshold value for the signal strength of the Sub1 192 signal may be configurable and may be stored in the memory 180.

In response to determining that the signal strength of the Sub1 192 signal from the first communication network 190 did not remain equal to or greater than a threshold value over the duration of the first specified time period of the first timer (245-N), the control unit 110 may control the communication unit 120 to continue performing the BPLMN search at block 220. In response to determining that the signal strength of the Sub1 192 signal from the first communication network 190 remained equal to or greater than a threshold value over the duration of the first specified time period of the first timer (245-Y), at block 250 the control unit 110 (e.g., the DDS detection manager 116) may control the timing unit 114 to reduce a second specified time period for a second timer. A reduced value for the second specified time period may be, for example, but not limited to, five seconds. The value for the second specified time period may be configurable and may be stored in the memory 180.

The second timer may be an inactivity timer for Sub2 197. At block 255 the control unit 110 (e.g., the DDS detection manager 116) may control the timing unit 114 to start the second timer. At block 260, the control unit may determine whether any data communication activity is taking place on Sub2 197 (i.e., whether Sub2 197 is idle) during the second specified time period for a second timer. In response to determining that no data communication activity is taking place on Sub2 197 during the second specified time period for a second timer (260-N), at block 265 the control unit 110 may control the timing unit 114 to reset the second timer and start the second timer at block 255. For example, the control unit 110 (e.g., the DDS detection manager 116) may control the timing unit 114 to reset the second timer to an initial value, for example zero seconds, whenever data communication activity is detected on Sub2 197 before the second specified time period for a second timer expires and then restart the timer from the initial value.

If the control unit 110 determines that Sub2 197 is idle during the second specified time period for a second timer (260-Y), at block 270 the control unit 110 may control the communication unit 120 to perform a DDS switch from Sub2 197 to Sub1 192. For example, the control unit 110 (e.g., the DDS detection manager 116) may control the communication unit 120 to transitions Sub2 197 to idle, release the data connection with the second communication network 195, and perform the DDS switch from Sub2 197 to Sub1 192.

The method 200 may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example examples.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific examples disclosed above may be combined in different ways to form additional examples, all of which fall within the scope of the present disclosure.

The foregoing method descriptions and the process flow diagrams are provided merely as illustrative examples and are not intended to require or imply that the operations of the various examples must be performed in the order presented. As will be appreciated by one of skill in the art the order of operations in the foregoing examples may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the examples disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various examples.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain examples and applications, other examples that are apparent to those of ordinary skill in the art, including examples which do not provide all of the features and advantages set forth herein, are also within the scope of this disclosure. Accordingly, the scope of the present disclosure is intended to be defined by reference to the appended claims.

What is claimed is:

1. A method for dynamically switching a data subscription in a multi subscriber identity module (SIM) multi standby (MSMS) mobile communication device, the method comprising:
in response to determining that signal energy for a first subscription detected during a background public land mobile network (BPLMN) search remains greater than or equal to a threshold signal energy value during a first specified time period of a first timer, reducing a second specified time period of a second timer for a second subscription;
determining whether any data communication activity occurs on the second subscription during the second specified time period;
in response to determining that no data communication activity occurs on the second subscription during the second specified time period, performing a dedicated data subscription (DDS) switch from the second subscription to the first subscription.

2. The method of claim 1, wherein the second timer is reset to a start of the second specified time period when data communication activity is detected on the second subscription during the second specified time period.

3. The method of claim 1, wherein the second timer is an inactivity timer for the second subscription.

4. The method of claim 1, further comprising:
in response to determining that the signal energy for the first subscription does not remain greater than or equal to the threshold signal energy value during the first specified time period,
re-initiating the BPLMN search for the first subscription;
in response to determining that the signal energy for the first subscription is detected, re-starting the first timer for the first specified time period.

5. The method of claim 1, wherein the BPLMN search for the first subscription is performed during gaps in data communication on the second subscription.

6. A multi subscriber identity module (SIM) multi standby (MSMS) mobile communication device, comprising:
a communication unit configured to communicate with one or more communication networks;
a memory operably connected to the communication unit;
a timing unit configured to implement one or more timers; and
a control unit operably connected to the communication unit, the memory, and the timing unit, the control unit configured to:
in response to determining that signal energy for a first subscription detected during a background public land mobile network (BPLMN) search remains greater than or equal to a threshold signal energy value during a first specified time period of a first timer, reduce a second specified time period of a second timer for a second subscription;
determine whether any data communication activity occurs on the second subscription during the second specified time period;
in response to determining that no data communication activity occurs on the second subscription during the second specified time period, perform a dedicated data subscription (DDS) switch from the second subscription to the first subscription.

7. The mobile communication device of claim 6, wherein the control unit controls the timing unit to reset the second timer to a start of the second specified time period when data communication activity is detected on the second subscription during the second specified time period.

8. The mobile communication device of claim 6, wherein the second timer is an inactivity timer for the second subscription.

9. The mobile communication device of claim 6, wherein the control unit is configured to:
in response to determining that the signal energy for the first subscription does not remain greater than or equal to the threshold signal energy value during the first specified time period,
control the communication unit to re-initiate the BPLMN search for the first subscription;
in response to determining that the signal energy for the first subscription is detected, control the timing unit to re-start the first timer for the first specified time period.

10. The mobile communication device of claim 6, wherein the control unit controls the communication unit to perform the BPLMN search for the first subscription during gaps in data communication on the second subscription.

11. The mobile communication device of claim 6, wherein values for the threshold signal energy, the first specified time period, and the second specified time period are stored in the memory.

12. A method for dynamically switching a data subscription in a multi subscriber identity module (SIM) multi standby (MSMS) mobile communication device, the method comprising:
initiating a background public land mobile network (BPLMN) search for a first communication network associated with a first subscription;
determining whether signal energy for the first subscription is detected;
in response to determining that the signal energy for the first subscription is detected, starting a first timer for a first specified time period;
monitoring the signal energy for the first subscription until expiration of the first specified time period;
determining whether the signal energy for the first subscription remains greater than or equal to a threshold signal energy value during the first specified time period; and
in response to determining that the signal energy for the first subscription remains greater than or equal to the threshold signal energy value during the first specified time period, performing a dedicated data subscription (DDS) switch from a second subscription to the first subscription.

13. The method of claim 12, further comprising:
in response to determining that the signal energy for the first subscription remains greater than or equal to the threshold signal energy value during the first specified time period, reducing a second specified time period of a second timer for the second subscription;
starting the second timer when no data communication activity occurs on the second subscription;
determining whether any data communication activity occurs on the second subscription during the second specified time period;
in response to determining that no data communication activity occurs on the second subscription during the second specified time period, performing a DDS switch from the second subscription to the first subscription.

14. The method of claim 13, wherein the second specified time period is configurable.

15. The method of claim 13, wherein the second timer is reset to a start of the second specified time period when data communication activity is detected on the second subscription during the second specified time period.

16. The method of claim 13, wherein the second timer is an inactivity timer for the second subscription.

17. The method of claim 12, further comprising:
in response to determining that the signal energy for the first subscription does not remain greater than or equal to the threshold signal energy value during the first specified time period,
re-initiating the BPLMN search for the first communication network associated with the first subscription;
determining whether the signal energy for the first subscription is detected;
in response to determining that the signal energy for the first subscription is detected, re-starting the first timer for the first specified time period.

18. The method of claim 12, wherein the BPLMN search for the first communication network associated with the first subscription is performed during gaps in data communication on the second subscription.

19. The method of claim 12, wherein the threshold signal energy value for the first subscription is configurable.

20. The method of claim 12, wherein the first specified time period is configurable.

21. A multi subscriber identity module (SIM) multi standby (MSMS) mobile communication device, comprising:
a communication unit configured to communicate with one or more communication networks;
a memory operably connected to the communication unit;
a timing unit configured to implement one or more timers; and
a control unit operably connected to the communication unit, the memory, and the timing unit, the control unit configured to:
control the communication unit to initiate a background public land mobile network (BPLMN) search for a first communication network associated with a first subscription;
determine whether signal energy for the first subscription is detected during the BPLMN search;
in response to determining that the signal energy for the first subscription is detected during the BPLMN search, control the timing unit to start a first timer for a first specified time period;
control the communication unit to monitor the signal energy for the first subscription until expiration of the first specified time period;
determine whether the signal energy for the first subscription remains greater than or equal to a threshold signal energy value during the first specified time period; and
in response to determining that the signal energy for the first subscription remains greater than or equal to the threshold signal energy value during the first specified time period, perform a dedicated data subscription (DDS) switch from a second subscription to the first subscription.

22. The mobile communication device of claim 21, wherein the control unit is configured to:
in response to determining that the signal energy for the first subscription remains greater than or equal to the threshold signal energy value during the first specified time period, control the timing unit to reduce a second specified time period of a second timer for the second subscription;
control the timing unit to start the second timer when no data communication activity occurs on the second subscription;
determine whether any data communication activity occurs on the second subscription during the second specified time period;
in response to determining that no data communication activity occurs on the second subscription during the second specified time period, perform a DDS switch from the second subscription to the first subscription.

23. The mobile communication device of claim 22, wherein the control unit controls the timing unit to reset the second timer to a start of the second specified time period when data communication activity is detected on the second subscription during the second specified time period.

24. The mobile communication device of claim 22, wherein the second timer is an inactivity timer for the second subscription.

25. The mobile communication device of claim 22, wherein the threshold signal energy value for the first subscription is configurable.

26. The mobile communication device of claim 22, wherein the first specified time period is configurable.

27. The mobile communication device of claim 22, wherein the second specified time period is configurable.

28. The mobile communication device of claim 22, wherein values for at least one of the threshold signal energy, the first specified time period, and the second specified time period are stored in the memory.

29. The mobile communication device of claim 21, wherein the control unit is configured to:
in response to determining that the signal energy for the first subscription does not remain greater than or equal to the threshold signal energy value during the first specified time period,
control the communication unit to re-initiate the BPLMN search for the first communication network associated with the first subscription;
determine whether the signal energy for the first subscription is detected;
in response to determining that the signal energy for the first subscription is detected, control the timing unit to re-start the first timer for the first specified time period.

30. The mobile communication device of claim 21, wherein the control unit controls the communication unit to perform the BPLMN search for the first communication network associated with the first subscription during gaps in data communication on the second subscription.
